(19) United States
(12) Patent Application Publication
(10) Pub. No.: US 2024/0424633 A1
(43) Pub. Date: Dec. 26, 2024

(54) METHOD FOR PRODUCING IMPROVED CUTTING EDGES

(71) Applicant: The Gillette Company LLC, Boston, MA (US)

(72) Inventors: Oliver Heinz CLAUS, Walpole, MA (US); Michael Joseph BAXTER, Jamaica Plain, MA (US); Thomas Richard SHEA, Arlington, MA (US); Michael Aaron BROWN, Quincy, MA (US); Kenneth Daniel BELLIVEAU, West Roxbury, MA (US); Joseph Allan DEPUYDT, Salem, NH (US)

(21) Appl. No.: 18/339,324

(22) Filed: Jun. 22, 2023

(51) Int. Cl. B24B 19/00; B23P 15/28

(52) U.S. Cl. CPC B24B 19/009; B23P 15/28

(57) ABSTRACT

A method is provided for forming cutting edges. The method includes a step of providing a grinding stage comprising a pair of abrading wheels that extend from a strip receiving end to a strip exiting end. The method further includes a step of directing a strip of metal at the strip receiving end of the grinding stage along a path P. The method also includes a step of removing material, from the strip of the metal, with an abrasive surface along the pair of abrading wheels which varies from a fine abrasion to a coarse abrasion in a direction from the strip receiving end to the strip exiting end.

### FIELD

The present disclosure relates generally to a novel method for providing improved cutting edges for cutting instruments such as razor blades and the like.

### BACKGROUND

Razor blades are produced by continuous, high-speed mass production techniques involving a plurality of sequential abrading operations to provide the cutting surface including the cutting edge. Each abrading operation provides a facet on opposed surfaces of the cutting surface and the facet may or may not be modified by subsequent abrading operations.

Typically, however, at least two or more abrading operations are used to provide the facets defining the cutting surface of the finished razor blade. In a system utilizing three abrading operations, a first operation is a grinding operation that involves abrading opposed surfaces of a continuous sheet of metal to provide a first or “ground” facet on opposed surfaces. In the grinding operation, one of the opposed edge surfaces of a strip of blade metal is abraded first while the other opposed surface is abraded later to provide the ground facet of the cutting-edge surface.

A second operation involves subjecting the metal sheet to a rough honing operation to provide a second facet or “rough honed facet” on the surfaces. A third operation, the finish honing operation, provides the final cutting-edge facets for opposed edge surfaces of the blade. In both the rough and finish honing operations, the opposed surfaces are abraded substantially simultaneously since the abrading means involved includes two juxtaposed abrading wheels.

U.S. Pat. No. 4,807,401 (“'401 patent” hereafter) discloses an apparatus for providing cutting edges for cutting instruments. The '401 patent teaches an apparatus with an improved grinding stage 16 including a pair of abrading wheels having rotational axes that extend from a strip receiving end to a strip exiting end of the grinding stage. The abrading wheels are oriented at a tilt angle relative to a path of a metal strip incident on the grinding stage such that the axes are more proximate to the path of the strip at the strip receiving end than at the strip exiting end. This tilt angle results in an outer surface of the abrading wheels making a smaller contact angle with the metal strip at the strip receiving end than the strip exiting end. The '401 patent also teaches that the outer surface of the abrading wheels is an abrasive surface that varies from a coarse abrasion to a fine abrasion in a direction from the strip receiving end to the strip exiting end. This variation in the abrasive surface facilitates a coarse abrasive surface grinding the strip of metal with a low contact angle at the strip receiving end of the grinding stage and a fine abrasive surface abrading the strip of metal with a high contact angle at the strip exiting end. This allows the coarser abrasive surface to remove a large portion of the metal strip (at the low contact angle) while allowing the finer abrasive surface to form a tip of the metal strip (at the high contact angle).

U.S. Pat. No. 3,461,616 (“'616 patent” hereafter) discloses an apparatus for providing cutting edges for cutting instruments. The '616 patent teaches an apparatus with an improved finishing stage 26 including a pair of abrading wheels having rotational axes that extend from a strip receiving end to a strip exiting end of the finishing stage. The abrading wheels are oriented at a tilt angle relative to a path of a metal strip incident on the finishing stage such that the abrading wheel axes are more proximate to the path of the strip of metal at the strip exiting end than at the strip receiving end. This tilt angle results in lands along an outer surface of the abrading wheels making a larger contact angle with the strip of metal at the strip receiving end relative to the strip exiting end. The '616 patent also teaches that the lands form a spiral helix such that the juxtaposed wheel can mesh with the lands of the wheel. This spiral helix arrangement facilitates continuous contact between the lands and the strip of metal as the contact angle between the lands and the metal strip varies from a high contact angle at the strip receiving end to a low contact angle at the strip exiting end.

Currently known abrading wheels and processes enable high-speed, continuous manufacture of razor blades. Despite the efficiencies of the production operations of these processes (e.g., apt removal of metal), there are still quality issues, such as tip asymmetry, edge roughness, and distortion, related to the edge of the blade that need to be improved upon. Accordingly, there is still a need for an improved apparatus and process for providing cutting edges for cutting instruments that overcomes the above noted quality issues in conventional processes and apparatuses.

### SUMMARY

Various aspects of the disclosure solve the above-mentioned problems and provide methods useful for providing cutting edges for cutting instruments. In a first aspect of the disclosure, a method is provided for forming cutting edges. The method includes a step of providing a grinding stage comprising a pair of abrading wheels that extend from a strip receiving end to a strip exiting end. The method further includes a step of directing a strip of metal at the strip receiving end of the grinding stage along a path P. The method also includes a step of removing material, from the strip of the metal, with an abrasive surface along the pair of abrading wheels which varies from a fine abrasion to a coarse abrasion in a direction from the strip receiving end to the strip exiting end.

In a second aspect of the disclosure, a method is provided for forming cutting edges. The method includes a step of providing a grinding stage including a pair of abrading wheels that extend from a strip receiving end to a strip exiting end. The pair of abrading wheels each comprise an abrasive surface that varies from a fine abrasion to a coarse abrasion in a direction from the strip receiving end to the strip exiting end. The method also includes a step of removing, with the abrasive surface of the pair of abrading wheels, material from a strip of metal incident on the strip receiving end along a path P. This removing step includes a step of removing material, from a tip of the strip of metal, with the abrasive surface having the fine abrasion and a step of removing material, along a distance from the tip of the strip of metal, with the abrasive surface having the coarse abrasion.

In a third aspect of the disclosure, a method is provided for forming cutting edges. The method includes a step of directing a strip of metal along a path P. The method further includes a step of removing, with a first grinding stage including a pair of abrading wheels, material from the strip of metal incident on the first grinding stage along the path P to form a first profile. The method further includes removing, with a second grinding stage including a pair of abrading wheels that extend from a strip receiving end to a strip exiting end, material from the first profile of the strip of material incident on the strip receiving end of the second grinding stage to form a second profile. This removing step includes a step of removing, with a fine abrasive surface of the pair of abrading wheels adjacent the strip receiving end, material from a tip of the first profile of the strip of metal to form a tip of the second profile. This removing step also includes a step of removing, with a coarse abrasive surface of the pair of abrading wheels adjacent the strip exiting end, material along a distance from the tip of the second profile of the strip of metal such that the removed material is directed away from the tip of the second profile.

These and other features, aspects, and advantages of various aspects will become better understood with reference to the following description, figures, and claims.

### BRIEF DESCRIPTION OF THE DRAWINGS

Many aspects of this disclosure can be better understood with reference to the following figures.

FIG. 1 is an example according to various aspects of the disclosure illustrating a side view of the razor-blade sharpening apparatus.

FIG. 2 is an example according to various aspects of the disclosure illustrating a top view of the second stage abrading wheels of the apparatus shown in FIG. 1.

FIG. 3 is an example according to various aspects of the disclosure illustrating a side view of one of the second stage abrading wheels shown in FIG. 2.

FIG. 4A is an example according to various aspects of the disclosure illustrating an end view of the second stage abrading wheels of FIG. 2 along the path P.

FIG. 4B is an example according to various aspects of the disclosure illustrating an end view of FIG. 2 showing a position of the tip of the metal strip and a center of rotation of the second stage abrading wheels along the second stage.

FIG. 5 is an example according to various aspects of the disclosure illustrating a side view of one of the second stage abrading wheels shown in FIG. 2.

FIG. 6A is an example according to various aspects of the disclosure illustrating a side perspective view of the strip of metal after the first and second stages of the apparatus of FIG. 1.

FIG. 6B is an example according to various aspects of the disclosure illustrating a cross-sectional view of the strip of metal after the first and second stages of the apparatus of FIG. 1.

FIG. 6C is an example according to various aspects of the disclosure illustrating a cross-sectional view of the strip of metal abraded during the second stage of the apparatus of FIG. 1.

FIG. 7 is an example according to various aspects of the disclosure illustrating a top view of the first stage abrading wheels of the apparatus shown in FIG. 1.

FIG. 8 is an example according to various aspects of the disclosure illustrating a side view of one of the first stage abrading wheels shown in FIG. 7.

FIG. 9 is an example according to various aspects of the disclosure illustrating a top view of the third stage abrading wheels of the apparatus shown in FIG. 1.

FIG. 10 is an example according to various aspects of the disclosure illustrating a side view of one of the third stage abrading wheels shown in FIG. 9.

FIG. 11 is an example according to various aspects of the disclosure illustrating a top view of all three stages and respective abrading wheels of the apparatus of FIG. 1.

FIG. 12 is an example according to various aspects of the disclosure illustrating a side view of all three stages and respective abrading wheels of the apparatus of FIG. 1.

FIG. 13 is an example according to various aspects of the disclosure illustrating traces that show a smoothness of the cutting edge formed with a conventional apparatus and with the apparatus of FIG. 1.

FIG. 14 is an example according to various aspects of the disclosure illustrating a flowchart depicting a method for providing cutting edges for cutting instruments.

It should be understood that the various aspects are not limited to the examples illustrated in the figures.

### DETAILED DESCRIPTION

It has been determined that a blade or cutting edge made in a high-speed continuous sharpening process has been found to have improved quality when the novel implementation of disclosure is applied and in particular when the second grinding stage, or the rough hone stage disclosed herein, in a three-step grinding process, is applied.

Specifically, the novel implementation of the second grinding stage of the disclosure includes a grinding wheel with a variation in abrasiveness, and preferably that finer grit or abrasive grinding is utilized at the strip receiving end of the grinding wheel and a coarser abrasive grinding is used at the strip exiting end (e.g., fine to coarse). The progressively coarser grinder may be appreciated in a gradual form across each grinding stage or in one stage alone. The notion of grinding from a finer grit to a coarser grit is counterintuitive and reverse to all the teachings of the prior art, where coarser abrasives are used at the strip receiving ends of the grinding wheels to remove more metal material and decrease to finer abrasives at the strip exiting ends when less material removal is needed.

In addition, the novel implementation of the disclosure includes a novel orientation or tilt of the abrading head of the second stage where the head is tilted at an angle relative to the strip, such that the helical grinding wheels contact the blade strip at a higher contact angle at the strip receiving end of the head and a lower contact angle at the strip exiting end. This contrasts with the prior art which has no tilt of the second stage grinding head or a tilt in a reverse direction than disclosed herein.

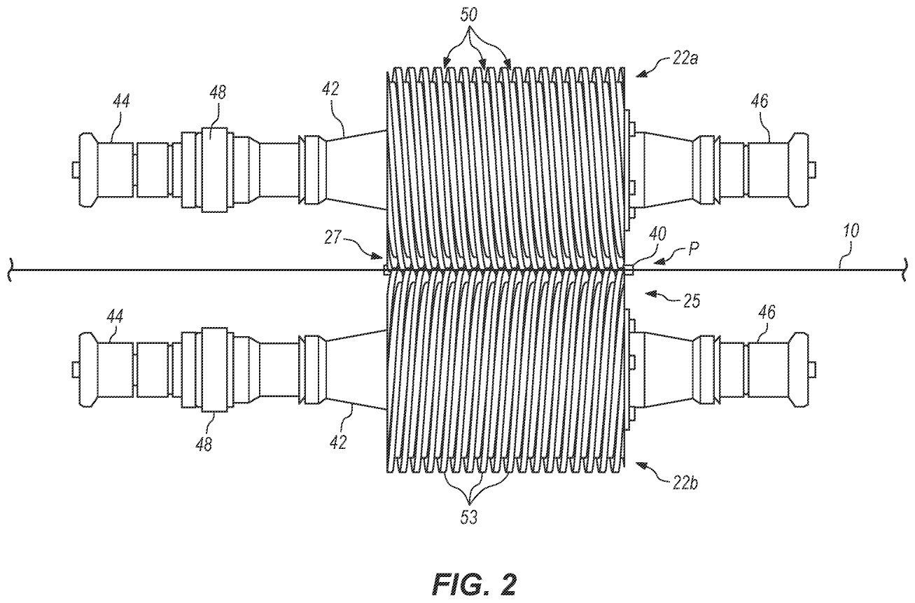

Still further, the novel implementation of the disclosure includes a helix orientation or arrangement of the abrading wheels of the second stage grinding head with a series of inter-engaged lands formed on them. A first abrading wheel 22a as shown in FIG. 2 includes lands 50 that have a right-hand thread orientation while a second abrading wheel 22b has a left-hand thread orientation. In the disclosure, these lands are oriented in a direction shown in FIG. 2 which is opposite to the land directions of second grinding stages in prior art arrangements. The disclosure beneficially results in continuous contact between the steel strip and the lands of the grinding wheel, in a direction from the tip down to the body, which reduces reversals at the blade tip.

It has been determined that, remarkably interdependently, the three aspects of tilt, grit progression, and helix orientation of the disclosure improve the quality of the blade cutting edge, and along with the equipment to enable this application, result in improved edge quality. This disclosure is written to a person having ordinary skill in the art, who will understand that this disclosure is not limited to the specific examples or aspects described. The examples and aspects are single instances of the disclosure which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and aspects only, and is not intended to be limiting, since the scope of the present disclosure will be limited only by the appended claims.

### Introduction and Definitions

This disclosure is written to describe to a person having ordinary skill in the art, who will understand that this disclosure is not limited to the specific examples or aspects described. The examples and aspects are single instances of the disclosure which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and aspects only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and aspects described herein are for illustrative purposes only and that various modifications or changes in light thereof will be suggested to the person having ordinary skill in the art and are to be included within the spirit and purview of this application. Many variations and modifications may be made to the aspects of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular aspects only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Strip receiving end” is an entry end of a grinding stage on which a strip is incident along a path P and is an opposite end of the grinding stage from the strip exiting end.

“Strip exiting end” is an exit end of a grinding stage from which a strip traveling along a path P exits the stage and is an opposite end of the grinding stage from the strip receiving end.

“Tilt angle” refers to an angle between rotational axes of abrading wheels of a grinding stage and a path P of a metal strip incident on the grinding stage.

“Contact angle” refers to an angle between a first direction orthogonal to a path P of a metal strip incident on a grinding stage and a second direction between a tip of the metal strip and a center of rotation of abrading wheels of the grinding stage.

“Helix orientation” refers to the direction that the lands of a helix wrap around an axis. Much like screw thread forms, left-handed threads of the disclosure run counter-clockwise and in a receding direction when viewed axially, whereas right-handed threads run clockwise and in a receding direction when viewed axially.

As used herein, the term “quality” as related to blades, signifies improvements to one or more of tip symmetry, edge smoothness, and minimized distortion. While strength and facet type (e.g., curved) are important, the quality of the blade is generally focused on sharpness. Thickness of the cross-section of the blade at various distances back from the tip of the blade is a fundamental measurement to determine sharpness. The thickness is generally measured using an interferometer.

### Apparatus for Providing Cutting Edges of a Cutting Instrument

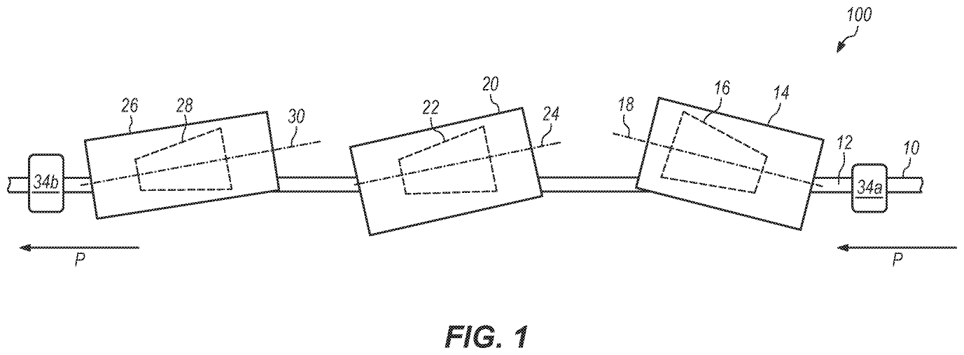

FIG. 1 is an example according to various aspects of the disclosure illustrating a side view of the razor-blade sharpening apparatus 100. The apparatus 100 includes a plurality of stages 14, 20, 26 which each abrade a strip 10 of metal that is incident on the stages along a path P. The stages 14, 20, 26 abrade the strip 10 to form a tip or upper blade edge 12 on the strip 10. The strip 10 of metal is passed from a first roll 34a through the stages 14, 20, 26 after which the strip 10 with the upper edge 12 is collected on a second roll 34b. The speed of the strip 10 fed through the wheels at each stage may be uniform or varying. In an example aspect of the disclosure, the speed may generally be between about 0.20 meters per second (m/sec) and about 0.40 m/sec. However, in other example aspects of the disclosure, the speed may be greater than this sample range. The apparatus 100 disclosed herein is capable of producing high quality blades with smooth facets, such as curved convex final facets, with an ultimate tip angle at the ultimate tip of the sharpened edge of the razor blade stock that is measured at a certain distance (e.g. 1 μm) from the tip. In one example aspect of the disclosure, the ultimate tip angle is in a range from about 25 degrees to about 35 degrees or more specifically within a range from about 27 degrees to about 32 degrees (e.g. calculated at 1 μm from the tip).

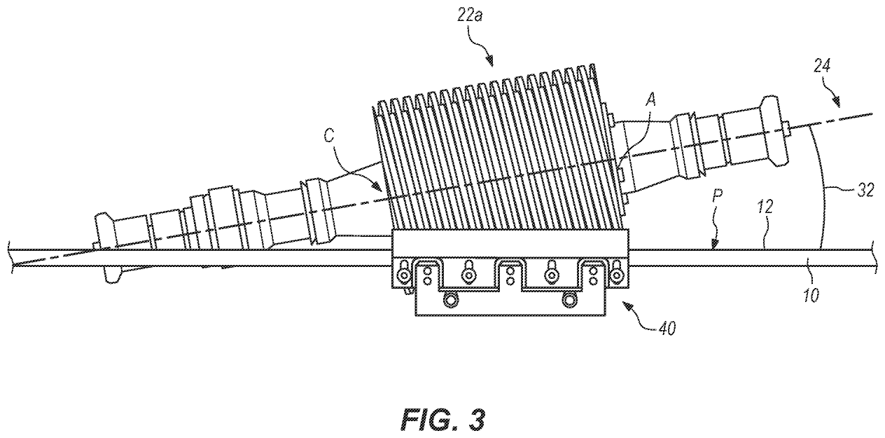

In the disclosure, the razor blade sharpening apparatus 100 centers on a novel second stage 20 in a multi-stage process of improving the quality of blades. Each stage however includes two abrading wheels of modified frustoconical configuration that are generally 7.6 centimeters (cm) to 22.9 cm long and have a radius between about 7.2 cm and 8.2 cm at their larger ends and a radius between about 6.7 cm and about 7.6 cm at their smaller ends. Each abrading wheel is manufactured of a suitably fine grade of abrasive material such as cubic boron nitride (CBN), silicon carbide, alumina, diamond, or a combination of such materials. The wheels are mounted for rotation about parallel axes. The wheels in each of the stages are inclined at a tilt angle 32 ranging between about 0.3 degrees and about 10 degrees relative to the blade path P defined by a blade holder 40 (e.g., as shown in FIG. 3). Grind wheels are generally rotated to contact the blade edge 12 from opposite sides in a downward direction.

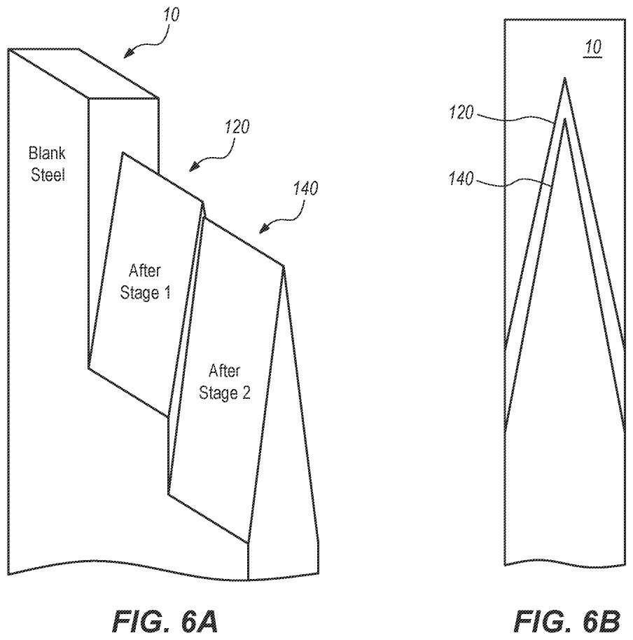

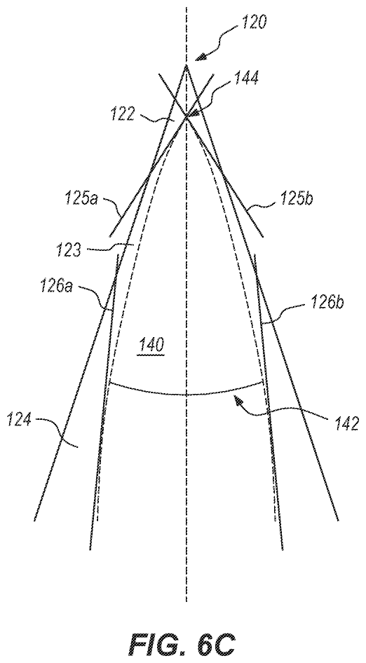

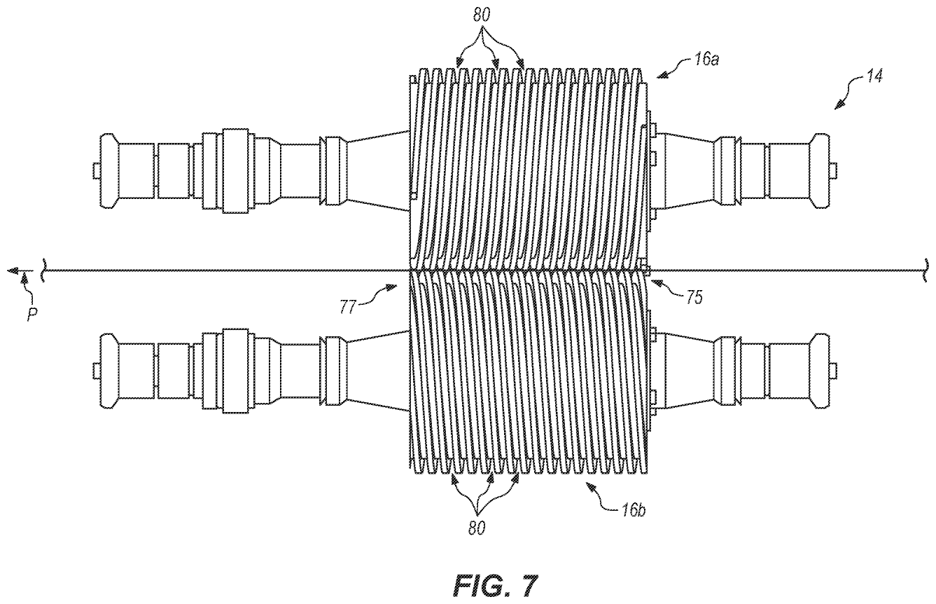

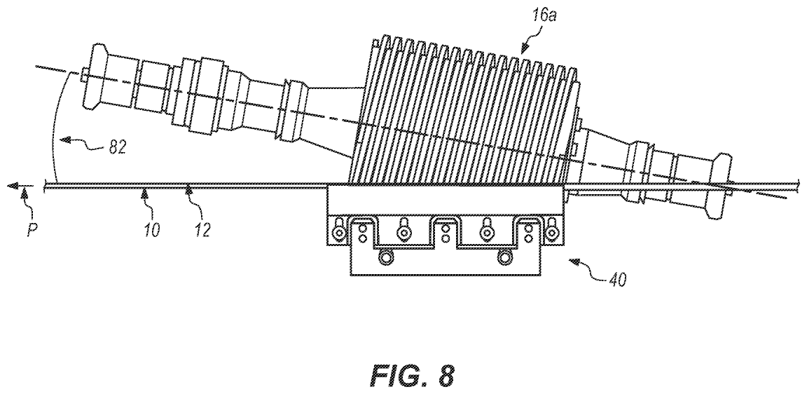

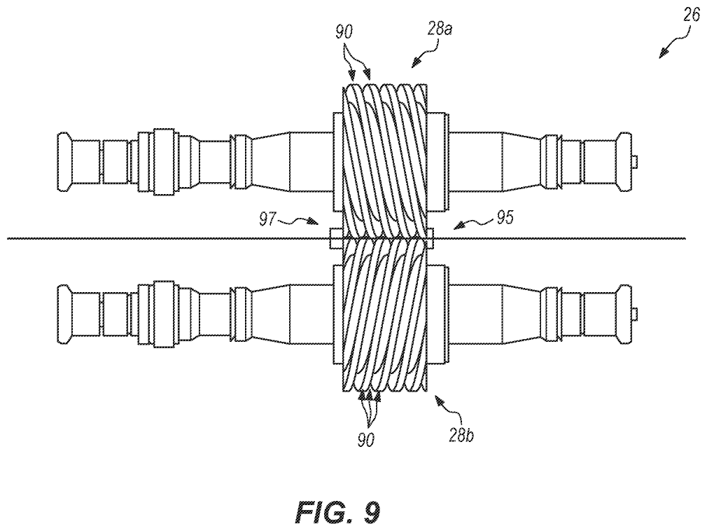

A first stage of the apparatus 100 will now be discussed. In one aspect of the disclosure, the first stage 14 is a grinding stage. As shown in FIG. 1, in one aspect the first stage 14 includes a pair of abrading wheels 16 that rotate about rotational axes 18. Abrading wheels 16 are rotated to contact the blade tip 12 from opposite sides in a downward direction. As indicated above, this is the first stage to remove metal from the strip 10. Preferably, more material is ground and removed in the first stage 14 than in subsequent stages 20 and 26. In this aspect of the disclosure, the axes 18 are angled relative to the path P of the strip 10 incident on the first stage 14. As further shown in FIG. 1, in one aspect of the disclosure the abrading wheels 16 have a frustoconical shape such that a diameter of the abrading wheels 16 is smaller at a strip receiving end than a strip exiting end of the first stage 14. A cross section of the metal strip 10 incident on the first stage 14 is shown in FIGS. 6A and 6B. The abrading wheels 16 of the first stage 14 grind the metal strip 10 (e.g. rectangular block shown in FIGS. 6A and 6B) resulting in a first profile 120 of the metal strip that is also shown in FIGS. 6A and 6B. The first stage 14 is discussed in greater detail with respect to FIGS. 7 and 8.

The razor blade or strip 10, which in this aspect is in continuous strip form, is of uniform width between about 2 mm and about 40 mm and a thickness between about 0.025 mm and about 0.150 mm, and is shown entering the apparatus 100 in the direction of the path P (e.g., from right to left). The blade strip 10 itself can be comprised of any metallurgical constituents (e.g., stainless steel, comprising iron, chromium, and carbon).

A second stage of the apparatus 100 will now be discussed. In one aspect of the disclosure, the second stage 20 is a rough honing stage. As shown in FIG. 1, in one aspect the second stage 20 includes a pair of abrading wheels 22 that rotate about rotational axes 24. In this aspect of the disclosure, the axes 24 are angled relative to the path P of the strip 10 to the second stage 20. As further shown in FIG. 1, in one aspect of the disclosure the abrading wheels 22 of the second stage 20 have a frustoconical shape such that a diameter of the abrading wheels 22 is larger at a strip receiving end than a strip exiting end of the second stage 20. A cross section of the first profile 120 of the metal strip incident on the second stage 20 is shown in FIGS. 6A and 6B. The abrading wheels 22 of the second stage 20 abrade the first profile 120 of the metal strip resulting in a second profile 140 of the metal strip that is also shown in FIGS. 6A and 6B. The second stage 20 is discussed in greater detail with respect to FIGS. 2 through 6.

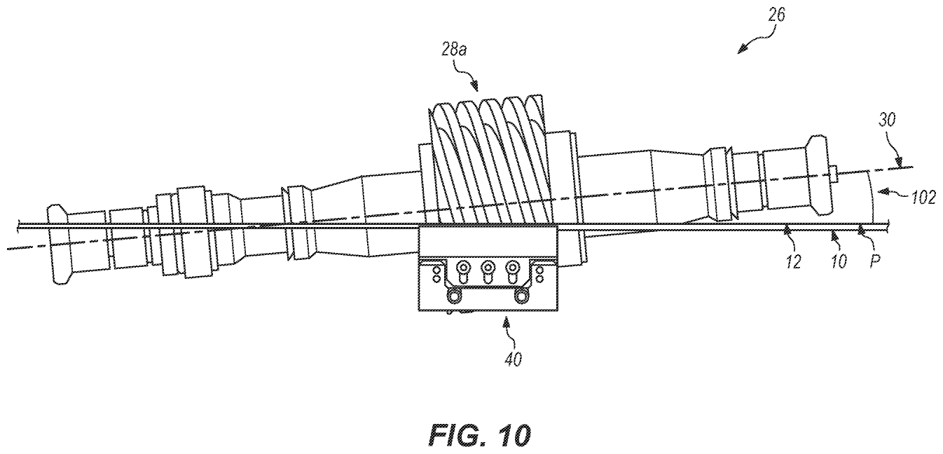

A third stage of the apparatus 100 will now be discussed. In one aspect of the disclosure, the third stage 26 is a finishing stage. As shown in FIG. 1, in one aspect the third stage 26 includes a pair of abrading wheels 28 that rotate about rotational axes 30. In this aspect of the disclosure, the axes 30 are angled relative to the path P of the strip 10 incident on the third stage 26. As further shown in FIG. 1, in one aspect of the disclosure the abrading wheels 28 of the third stage 26 have a frustoconical shape such that a diameter of the abrading wheels 28 is larger at a strip receiving end than a strip exiting end of the third stage 26. A cross section of the second profile 140 of the metal strip incident on the third stage 26 is shown in FIGS. 6A and 6B. The third stage 26 is discussed in greater detail with respect to FIGS. 9 and 10.

The second stage 20 will now be discussed in more detail. FIG. 2 is an example according to various aspects of the disclosure illustrating a top view of the second stage abrading wheels 22a. 22b of the apparatus 100 shown in FIG. 1. As shown in FIG. 2, in one aspect of the disclosure the abrading wheels 22a, 22b each define a strip receiving end 25 facing the first grinding stage 14 and a strip exiting end 27 that is opposite to the strip receiving end 25. In accordance with one aspect of the disclosure, each abrading wheel 22a, 22b is mounted on a spindle 42 that includes bearing mounts 44, 46. In one example aspect of the disclosure, the centers of the bearing mounts 44, 46 are spaced apart by a distance between about 38.1 cm and about 55.9 cm, depending on the configuration. A drive gear 48 is positioned on each spindle 42 between the bearing mount 44 and the abrading wheels 22a, 22b. The facet surfaces of the strip 10 held in a blade holder or support 40 are ground in the second stage 20 by these two juxtaposed abrading wheels 22a, 22b.

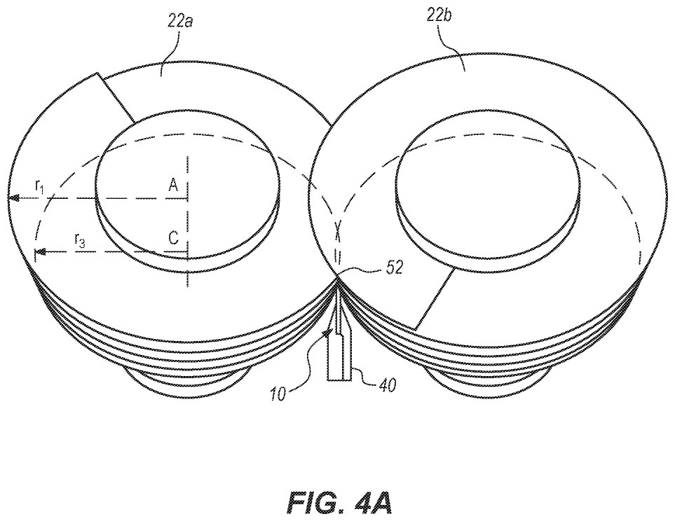

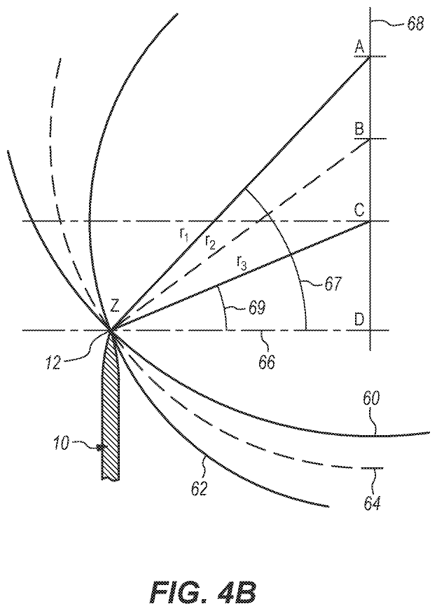

Helical lands along an outer surface of the second stage abrading wheels are now discussed. Each abrading wheel 22a, 22b of the second stage 20 has one or more helical lands 50 formed in circumferential surfaces so that the two wheels are in inter-engagement and define a nip 52 (shown in FIG. 4A) between them. As shown in FIG. 4A, the strip 10 passes through the nip 52 when the wheels 22a, 22b are juxtaposed in a honing position. As shown in FIG. 2, the lands 50 define an abrasive surface 53 that varies from a fine abrasion to a coarse abrasion in a direction from the strip receiving end 25 to the strip exiting end 27. FIG. 2 is an example according to various aspects of the disclosure illustrating a top view of one of the second stage abrading wheels 22 shown in FIG. 2. As shown in FIG. 2, in one aspect of the disclosure the lands 50 are arranged in a spiral helix such that the orientation of the helix maintains a right-hand orientation for the upper wheel 22a in FIG. 2, and a left-hand orientation for the lower wheel 22b in FIG. 2. In an example aspect of the disclosure, the lead of the helix is within a range of about 0.63 cm to about 5.08 cm, preferably within a range of about 1.90 cm to about 3.81 cm. It was recognized that the helical arrangement of the lands 50 in FIG. 2 advantageously results in continuous contact between the lands 50 and the strip of metal 10 in a direction from the tip of the blade 12 to a distance farther away from the tip and closer to the blade body, as the strip 10 passes from the strip receiving end 25 to the strip exiting end 27 of the second stage 20.

A tilt angle of the second stage abrading wheels is now discussed. FIG. 3 is an example according to various aspects of the disclosure illustrating a side view of one of the second stage abrading wheels 22 shown in FIG. 2. As shown in FIG. 3, in one aspect of the disclosure, the rotational axes 24 of the abrading wheels 22a, 22b is oriented at a tilt angle 32 relative to the direction P of the strip 10 of metal incident on the second stage 20. As further shown in FIG. 3, the tilt angle 32 is selected such that the axes 24 are oriented to be more proximate to the path P at the strip exiting end 27 than at the strip receiving end 25. In an example aspect of the disclosure, the tilt angle 32 is selected within a range from about 0.3 degrees to about 10 degrees.

FIG. 4A is an example according to various aspects of the disclosure illustrating an end view of the second stage abrading wheels 22a, 22b of FIG. 2 along the path P. FIG. 4B is an example according to various aspects of the disclosure illustrating an end view of FIG. 2 showing a position of the tip 12 of the metal strip 10 and a center of rotation A, C of the second stage abrading wheels 22a, 22b along the second stage 20. FIG. 4B depicts the center of rotation A of the abrading wheels 22a, 22b at the strip receiving end 25 and the center of rotation C of the abrading wheels 22, 22b at the strip exiting end 27. As previously discussed, the abrading wheels 22a, 22b are frustoconical where the diameter of the abrading wheels 22a, 22b is larger at the strip receiving end 25 than at the strip exiting end 27. FIG. 4B illustrates the geometry of one of the wheels 22a relative to the edge 12 of the blade 10. The larger circumferential arc 60 of the wheel 22a at the strip receiving end 25 and the smaller circumferential arc 62 of the wheel 22a at the strip exiting end 27 are both depicted in FIG. 4B. An intermediate arc 64 is also depicted between the larger circumferential arc 60 and the smaller circumferential arc 62. The path P of the blade edge 12 is perpendicular to line 66 (into the plane of FIG. 4B). The rotational axes 24 of the abrading wheel 22a follows line 68 from the strip receiving end 25 (A in FIG. 4B) to the strip exiting end 27 (C in FIG. 4B).

A contact angle between the second stage abrading wheels and the metal strip is now discussed. The contact angle between the tip 12 of the metal strip 10 and the abrading wheels 22a, 22b is an angle between a first direction that is orthogonal to the path P of the strip 10 and a second direction between the tip 12 and the center of rotation of the abrading wheels. In one example aspect of the disclosure, the contact angle 67 at the strip receiving end 25 is depicted in FIG. 4B between the first direction (line 66) that is orthogonal to the path P and the second direction (r₁) between the tip 12 and the center of rotation A of the abrading wheel at the strip receiving end 25. In another example aspect of the disclosure, the contact angle 69 at the strip exiting end 27 is depicted in FIG. 4B between the first direction (line 66) that is orthogonal to the path P and the second direction (r₃) between the tip 12 and the center of rotation C of the abrading wheel at the strip exiting end 27. In other aspects of the disclosure, the first direction is defined by a plane in which the metal strip 10 moves along path P. As shown in FIG. 4B, in one aspect of the disclosure the contact angle 67 at the strip receiving end 25 is greater than the contact angle 69 at the strip exiting end 27. In one example aspect of the disclosure, the contact angle 67 at the strip receiving end 25 is in a range from about 9 degrees to about 11 degrees and the contact angle 69 at the strip exiting end 27 is in a range from about 7 degrees to about 9 degrees. Accordingly, a value of the contact angle diminishes in a direction from the strip receiving end 25 to the strip exiting end 27 of the second stage 20. Additionally, since the wheels 22a, 22b are frustoconical, the diameter of each wheel 22a, 22b changes along its length so that the wheel is effectively tapered which also causes the contact angle between the abrasive surface 53 at the intersection nip 52 to change along the length.

Since the contact angle 67 is greater at the strip receiving end 25 of the second stage 20, the lands 50 of the abrading wheels 22a, 22b are oriented to contact the tip 12 of the metal strip 10 at the strip receiving end 25 and thus abrade the metal strip 10 to form the tip 12. Similarly, since the contact angle 69 is smaller at the strip exiting end 27 of the second stage 20, the lands 50 of the abrading wheels 22a, 22b are oriented to contact a distance back from the tip 12 at the strip exiting end 27 to advantageously induce or create less pressure near the tip and more pressure away from the tip.

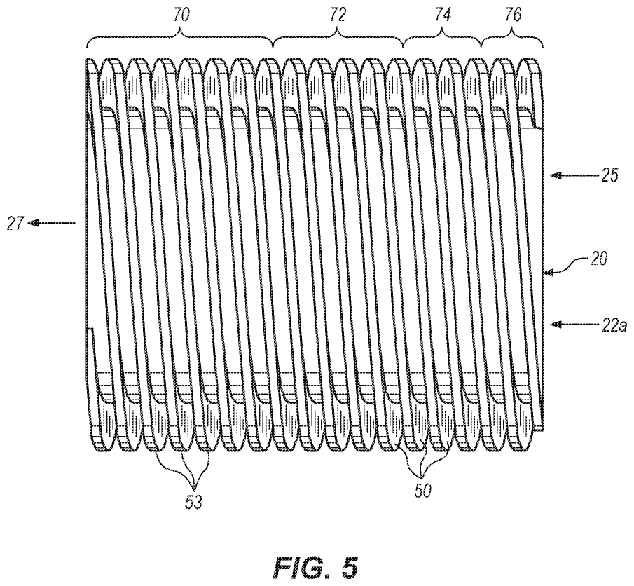

The abrasive characteristics of the second stage abrading wheels will now be discussed. FIG. 5 is an example according to various aspects of the disclosure illustrating a side view of one of the second stage abrading wheels 22 shown in FIG. 2. As shown in FIG. 5, the second stage abrading wheel 22 includes the lands 50 that are divided into a plurality of sections 70, 72, 74, 76. In an aspect of the disclosure, a level of coarseness of the abrasive surface 53 of the lands 50 varies between the sections 70, 72, 74, 76. In an example aspect of the disclosure, the coarseness of the abrasive surface 53 varies from a fine abrasive surface in the section 76 adjacent to the strip receiving end 25 to increasingly coarse abrasive surfaces in each of the next sections 74, 72, 70. In this example aspect of the disclosure, the abrasive surface 53 has the highest degree of coarseness in the section 70 that is adjacent to the strip exiting end 27. In an example aspect of the disclosure, the fine abrasive surface in section 76 has a coarseness of about 1-10 μm while the coarse abrasive surface in section 70 has a coarseness of about 50-100 μm. It was recognized that this variation in the coarseness of the grit of the abrasive surface 53 in the sections 70, 72, 74, 76 advantageously positions the section 76 with the fine abrasive surface adjacent to the strip receiving end 25 that makes a relatively high contact angle 67 with the metal strip 10 and thus can shape the tip 12 of the metal strip 10. Similarly, it was recognized that this variation in the coarseness of the abrasive surface 53 in the sections 70, 72, 74, 76 advantageously positions the section 70 having the most coarse abrasive surface adjacent to the strip exiting end 27 which makes a relatively low contact angle 69 with the metal strip 10 and thus can abrade and remove a large amount of material from the metal strip 10 at a distance separated from the tip 12. It was further recognized that since the abrasive surface 53 moves in a downward direction on the strip 10 (see FIG. 2 where the abrasive surface 53 of each abrading wheel 22a, 22b moves into the plane of the figure at the strip 10) that the abrading of the metal strip 10 with the coarse abrasive surface of section 70 advantageously directs removed metal in a region away from the tip 12. This advantageously ensures the structural integrity of the tip 12 that was formed by the section 76 adjacent to the strip receiving end 25.

Although four sections of varying coarseness are depicted in the abrading wheel 22 of FIG. 5, the aspect of the disclosure is not limited to four sections and can include less or more than four sections with varying coarseness in the abrasive surface 53. Furthermore, although FIG. 5 depicts that the sections 70, 72, 74, 76 have varying widths (along the axes 24) this is just one example aspect and in other aspects of the disclosure the widths of these sections could be different.

The change in the profile of the metal strip 10 as it moves through the first and second stages 14, 20 of the apparatus 100 is now discussed. FIGS. 6A and 6B are examples according to various aspects of the disclosure illustrating a side perspective view and cross-sectional view of the strip 10 of metal after the first and second stages 14, 20 of the apparatus of FIG. 1. In one aspect of the disclosure, the metal strip 10 incident on the first stage 14 is a rectangular block of metal. The abrading wheels 16 of the first stage 14 grind the metal strip 10 such that the profile of the metal strip 10 changes from the rectangular block to the first profile 120 depicted in FIGS. 6A and 6B. This first profile 120 of the metal strip 10 is then incident on the abrading wheels 22a, 22b of the second stage 20. Based on the abrasion of the first profile 120 of the metal strip 10 with the abrading wheels 22a, 22b, the second profile 140 is formed which is also depicted in FIGS. 6A and 6B. It should be noted that the specific first and second profiles 120, 140 depicted in FIGS. 6A and 6B are merely one example aspect of profiles of the metal strip 10 after the respective first and second stages 14, 20 and that these profiles could vary from what is depicted.

The change in the profile of the metal strip 10 between the strip receiving end 25 and the strip exiting end 27 of the second stage 20 will now be discussed. FIG. 6C is an example according to various aspects of the disclosure illustrating a cross-sectional view of the strip of metal abraded during the second stage of the apparatus of FIG. 1. As shown in FIG. 6C, the first profile 120 of the metal strip 10 is incident on the second stage 20. At the strip receiving end 25 of the abrading wheels 22a, 22b, the fine abrasive surface 53 in section 76 contacts the first profile 120 at the high contact angle 67 (FIG. 4B) and removes material in section 122 to form the tip 144 of the second profile 140 of the metal strip. As shown in FIG. 6C, in an aspect of the disclosure the lines 125a, 125b depict the direction at which the fine abrasive surface 53 in section 76 engages the first profile 120 and removes the material in section 122 at the high contact angle 67 to form the tip 144. Additionally, at the strip exiting end 27 of the abrading wheels 22a, 22b, the coarse abrasive surface 53 in section 70 contacts the first profile 120 at the low contact angle 69 (FIG. 4B) and removes material in section 124 to form a bevel surface and reduce a thickness of the second profile 140 formed by the second stage 20. As shown in FIG. 6C, in an aspect of the disclosure, the lines 126a, 126b depict the direction at which the coarse abrasive surface 53 in section 70 engages the first profile 120 and removes the material in section 124 at the low contact angle 69 to reduce the thickness of the second profile 140. Additionally, as shown in FIG. 6C in one example aspect, between the strip receiving end 25 and the strip exiting end 27 of the abrading wheels 22a, 22b, the abrasive surface 53 in sections 72, 74 contacts the first profile 120 at a contact angle (e.g., between the high contact angle 67 and low contact angle 69) and removes material in section 123.

As shown in FIG. 6C, the abrasive surface is shaped to advantageously displace the location of maximum pressure on the strip in a direction away from the tip and towards the flank as the strip progresses from the strip receiving end to the strip exiting end of the wheels. Given that the strip is quite thin and the tip deflects readily under increased force or pressure from the wheels, this arrangement minimizes the force or pressure being exerted at the tip. Although FIG. 6C only depicts three sections 122, 123, 124 removed by the sections 70, 72, 74, 76 of the abrasive surface 53, this is for case of illustration and in other aspects of the disclosure less or more than three sections could be removed (e.g. four sections could be removed by the four sections of the abrasive surface 53, or more than four sections could be removed if more than four sections with varying degrees of coarseness are provided for the abrasive surface 53, etc.). As previously discussed, FIG. 6C depicts how it is advantageous to have the coarse abrasive surface 53 of the section 70 remove the section 124 in a downward direction (looking at FIG. 6C) since this smears the removed section 124 away from the tip 144 that was formed at the strip receiving end 25. A non-limiting aspect of the disclosure provides the grinding occurring where facet contact is worked from the tip to the body of the blade edge as the strip progresses from strip receiving to strip exiting ends of the wheels. In this way, the ultimate tip 144 of the blade edge is abraded first and for points on the blade edge that are increasingly remote from the ultimate tip 144, these are subsequently abraded in a manner that avoids further contact with the ultimate tip 144. This serves to reduce tip pressure at the strip exiting end 27 of the second stage 20, while also enabling low grind angles.

In some aspects of the disclosure, the second profile 140 formed by the second stage 20 has one or more parameter values which characterize a quality of the cutting edge used for the cutting instrument. Although these parameter values characterize the quality upstream of the third finishing stage 26, they nevertheless affect the quality of the cutting edge formed by the apparatus 100. In one aspect of the disclosure, the parameter is a grind angle 142 measured at about a midpoint of a bevel of the second profile 140. In an example aspect of the disclosure, the value of the grind angle 142 is within a range between about 12 degrees and about 18 degrees or preferably between about 13 degrees and about 15 degrees. It should be recognized that FIG. 6C is not drawn to scale and thus is merely for illustrative purposes.

The first stage of the apparatus 100 will now be discussed in more detail. FIG. 7 is an example according to various aspects of the disclosure illustrating a top view of the first stage 14 abrading wheels 16a, 16b of the apparatus 100 shown in FIG. 1. FIG. 8 is an example according to various aspects of the disclosure illustrating a side view of one of the first stage abrading wheels 16a shown in FIG. 7. As can be seen in FIGS. 7 and 8, the setup of the abrading wheels 16a, 16b is generally similar to the second stage abrading wheels 22a, 22b of FIG. 2. For instance, the wheels 16a, 16b are mounted and held in place using mounts and gears as shown in FIG. 2 and the strip 10 is supported by a blade support 40, as also shown in FIG. 2. However, a main difference can be seen in FIG. 7 and FIG. 8 in that the helical orientation or arrangement of the lands 80 of the wheels 16a, 16b is opposite to that of FIG. 2. These lands 80 shown in FIG. 7 are oriented such that they form a left-hand thread on the upper wheel 16a, and a right-hand thread on the lower wheel, 16b. Additionally, the lands 80 are oriented from each of the upper and lower second stage wheels 16a and 16b such that they form a low contact angle at the strip receiving end 75 and a high contact angle at the strip exiting end 77. In some aspects of the disclosure, the lands 80 have an abrasive surface that varies from a coarse abrasive surface adjacent to the strip receiving end 75 to a fine abrasive surface adjacent to the strip exiting end 77. Thus, the lands 80 initially abrade the metal strip 10 at the strip receiving end 75 with a coarse abrasive surface at a low contact angle (e.g. to remove metal from the strip 10 a distance back from the tip 12) and later abrade the metal strip 10 at the strip exiting end 77 with a fine abrasive surface at a high contact angle (e.g. to form the tip 144 of the first profile 120 that is incident on the second stage, see FIG. 6C). However, in other aspects of the disclosure, the lands 80 do not have an abrasive surface with varying coarseness between the strip receiving and strip exiting ends 75, 77.

As can be seen in FIG. 8, the tilt angle 82 of the first stage 14 is shown. Here, the spindles 42 of FIG. 8 are mounted for rotation about parallel axes 18 that are desirably inclined at the tilt angle 82 relative to the path P, where the tilt angle 82 is about 0.3 degrees to about 10 degrees. This tilt angle 82 of the wheels 16 of the first stage 14 is directed downward from left to right such that the axis 18 is closer to the path P at the strip receiving end 75 than at the strip exiting end 77. Having such a tilt angle 82 in the first stage 20 is the opposite arrangement of the second stage tilt angle 32 described supra with regard to FIG. 3.

The third stage of the apparatus 100 will now be discussed in more detail. FIG. 9 is an example according to various aspects of the disclosure illustrating a top view of the third stage abrading wheels 28a, 28b of the apparatus 100 shown in FIG. 1. FIG. 10 is an example according to various aspects of the disclosure illustrating a side view of one of the third stage abrading wheels 28a shown in FIG. 9. The third stage 26 is the finish grinding stage. This stage finalizes the formation of the blade. FIG. 9 depicts a top view of the third stage 26 and as shown, the helical arrangements of the wheels 28a, 28b are similar to the second stage 20 in that the lands 90 of the wheels are oriented such that from each of the upper and lower third stage wheels 28a and 28b they meet at the strip receiving end 95 by each forming a higher contact angle than at the strip exiting end 97 relative to the blade tip 12. It is noted that the number of lands 90 of wheels 28 are less than the number of lands 50 and 80 in the second and first stages, respectively.

Moreover, as shown in FIG. 10, a tilt angle 102 is selected in the third finish stage 26 that is similar to or higher than the tilt angle 32 of the second stage 20. This can be seen at the finish honing operation at the third grinding stage 26 depicted by a pair of finish honing wheels 28a, 28b mounted for rotation about axes 30. The tilt angle 102 is selected such that a similar or higher tilt as the second stage 20 can be seen at the finish honing operation at the third finishing stage 26 depicted by the pair of abrading wheels 28 mounted for rotation about axes 30. The tilt angles shown in each of the stages in FIG. 1 are for illustrative purposes and slightly exaggerated.

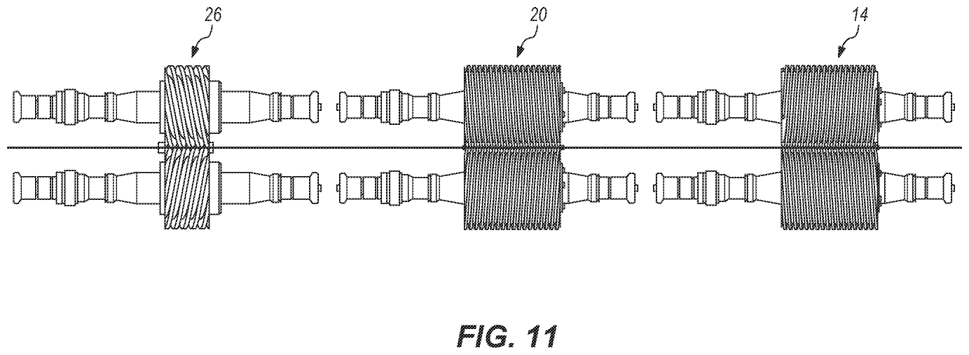

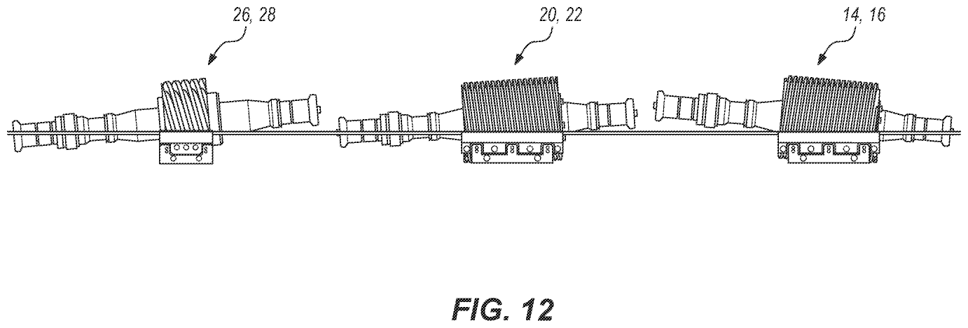

FIG. 11 is a diagrammatic top view of wheels of all three stages 14, 20, and 26 and respective wheels combined together disposed in the configuration employed in the apparatus shown in FIG. 1 in the practice of the disclosure. FIG. 12 is a diagrammatic side view of wheels of all three stages 14, 20, and 26 and respective wheels combined together and disposed in the configuration employed in the apparatus shown in FIG. 1 in the practice of the disclosure.

When all three stages are combined together as shown and described, and when the second stage desirably has one or more of the novel characteristics noted above (e.g., fine-to-coarse abrasion, tilt angle, helical wheels arranged with large contact angle relative to the blade at entry and a helix orientation as shown in FIG. 2), a blade edge is provided that has the capacity to reach a most optimal enhanced quality.

It was recognized that the improved apparatus 100 for providing cutting edges for cutting instruments overcomes the above noted quality issues in conventional processes and apparatuses. Additionally, it was recognized that the improved apparatus 100 includes the second stage 20 between the first stage 14 and the third stage 26, where the second stage 20 combined various aspects of the first stage 14 and the third stage 26 in an unorthodox way. For example, the second stage 20 of the improved apparatus includes the pair of abrading wheels 22 with the tilt angle 32 that is similar to the tilt angle 102 of the abrading wheels 28 of the third stage 26 (FIG. 10). As with the third stage 26, this tilt angle 32 of the second stage 20 results in the outer surface of the abrading wheels 22 making a higher contact angle with the metal strip 10 at the strip receiving end 25 relative to the strip exiting end 27. In another example, the abrading wheels 22 of the second stage 20 feature lands 50 having a spiral helix with similar orientation as the lands 90 of the third stage 26 (FIG. 9). As with the third stage 26, this shaped helix results in continuous contact between the lands 50 and the metal strip 10 as the contact angle varies from the high contact angle at the strip receiving end 25 to the low contact angle at the strip exiting end 27. Additionally, the lands 50 of the second stage 20 feature an abrasive surface whose coarseness varies in a reverse manner to the abrasive surface in the first stage 14 such that the abrasive surface varies from a fine abrasion to a coarse abrasion in a direction from the strip receiving end 25 to the strip exiting end 27. This variation of the abrasive surface advantageously results in a fine abrasive surface abrading the metal strip 10 at a high contact angle at the strip receiving end 25 (e.g. to form the tip of the metal strip) and a coarse abrasive surface abrading the metal strip 10 at a low contact angle at the strip exiting end 27 (e.g. to remove a large portion of the metal strip away from the formed tip).

Having produced a sharpened blade edge after undergoing these grinding stages, it is noted that there are many different methods of characterizing the quality of the blade. Sharpness is the most determinative manner in assessing the quality of the blade edge. A fundamental method of measuring sharpness is measuring the thickness (e.g. T4, T8, T16, T40) of the cross-sectional profile of the sharpened edge.

Interferometry has long been considered for assessing edge sharpness, going back at least to A. Mallock (1896). Note on the radius of curvature of a cutting edge, Philosophical Transactions 1896, p. 164-167. Referenced from Mallock, A. (1881). The action of cutting tools, Proceedings of the Royal Society, XXXIII, 127-139. Other approaches for thickness measurement include laser-based systems, confocal microscopy or scanning probe approaches such as Atomic Force Microscopy. Within the broad space of interferometry, there are also various different techniques which may be useful. One particular interferometric method used in this work, known as fringe tracing, is an analysis of static interferograms which have been generated by Mirau or Michelson-type interferometers. This technique can be used for measuring the grind angles 142 (FIG. 6C), which are generally measured at approximately a midpoint of the bevel. It can also be used for determining cross-sectional thickness values at points closer to the tip such as T4, T8, T16 and T40 (FIG. 6C), which are the profile thicknesses at given distances (e.g., 4 μm, 8 μm, 16 μm or 40 μm) back from the ultimate tip 144. With the proper physical angle of orientation of the blade edge in two different planes relative to the optical axis of the interferometer, an interferogram is generated which represents the shape of the blade tip. The cross-sectional thickness can then be determined by tracing or skeletonizing the fringe pattern, and then analyzing the tracing to convert the tracing data to half-thickness data. Tracing and analyzing the fringe patterns for each side of the edge at a given location, and adding the half-thicknesses together, yields the total cross-section thickness, or sharpness of the edge. This method is very cost-effective and production friendly, with the use of digital cameras and image processing technology that is available.

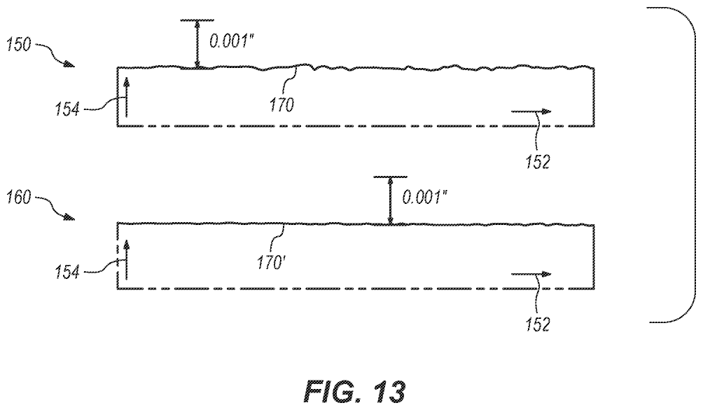

FIG. 13 is an example according to various aspects of the disclosure illustrating traces that show a smoothness of the cutting edge formed with a conventional apparatus and with the improved apparatus of FIG. 1. FIG. 13 depicts two graphs 150, 160 which each have a horizontal axis 152 that indicates position along a length of the metal strip (arbitrary units) and a vertical axis 154 along a height of the metal strip (arbitrary units). A scalebar of the vertical axis 154 is shown in FIG. 13. The first graph 150 includes a trace 170 that indicates a formed cutting edge in a metal strip using a conventional cutting apparatus (e.g. '401 patent or '616 patent). The second graph 160 includes a trace 170′ that indicates a formed cutting edge in a metal strip using the improved apparatus 100 disclosed herein. As shown in the graphs 150, 160 the trace 170′ is much smoother than the trace 170 along the length of the metal strip which confirms that the cutting edge formed with the apparatus 100 disclosed herein is much smoother than the cutting edge formed with the conventional apparatus. In an aspect of the disclosure, the traces 170, 170′ are generated by positioning a light source on one side of the metal strip and a light detector on an opposite side of the metal strip. The trace 170, 170′ is then generated based on the detected light at the detector, which indicates the position of the cutting edge. It should be emphasized that the traces 170, 170′ indicate the smoothing of the cutting edge after the second stage and thus not after all stages of the apparatus. Thus, in an example aspect of the disclosure the trace 170′ indicates a smoothness of the tip 144 in the second profile 140 (that is formed by the second stage 20).

### Method for Providing Cutting Edges of a Cutting Instrument

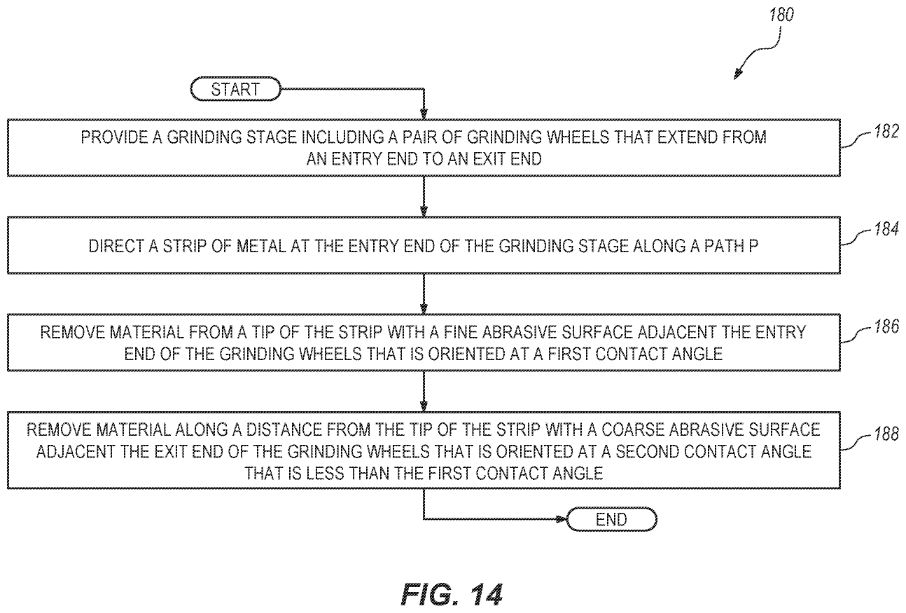

A method to form a cutting edge to be used with a cutting instrument is now discussed. In one aspect of the disclosure, the method is performed by the apparatus 100 disclosed herein. Although steps are depicted in FIG. 14 as integral steps in a particular order for purposes of illustration, in other aspects, one or more steps, or portions thereof, are performed in a different order, or overlapping in time, in series or in parallel, or are omitted, or one or more additional steps are added, or the method is changed in some combination of ways.

FIG. 14 is an example according to various aspects of the disclosure illustrating a flowchart depicting a method 180 for providing cutting edges for cutting instruments. In one aspect, in step 182 an apparatus 100 is provided including the second grinding stage 20. In some aspects of the disclosure, the apparatus 100 is provided that includes the first stage 14, the second stage 20 and the third stage 26, as disclosed herein.

In an aspect of the disclosure, in step 184 the metal strip 10 is directed at an entry end, such as the strip receiving end 25 of the grinding stage 20 along the path P. In some aspects of the disclosure, before step 184 the metal strip 10 is incident on the first stage 14 and the metal strip 10 is abraded by the first stage 14 to form the first profile 120. In this aspect of the disclosure, in step 184 the first profile 120 of the metal strip is incident at the strip receiving end 25 of the second stage 20.

In an aspect of the disclosure, in step 186 material is removed from the metal strip incident on the second stage 20. In one aspect of the disclosure, in step 186 metal is removed from the metal strip (first profile 120) incident on the second stage 20 to form a tip 144. In this example aspect of the disclosure, in step 186 the fine abrasive surface 53 in section 76 of the abrading wheels 22a, 22b adjacent to the entry end, such as the strip receiving end 25, abrades the first profile 120 of the metal strip at a high contact angle 67 (FIG. 4B) and forms the tip 144 in the metal strip. In this example aspect of the disclosure, in step 186 the section 122 (FIG. 6C) is removed from the first profile 120 of the metal strip by the fine abrasive surface 53 at the high contact angle 67. In an example aspect of the disclosure, in step 186 the fine abrasive surface 53 in section 76 abrades the first profile 120 in a direction along lines 125a, 125b (FIG. 6C) at the high contact angle 67 to remove the section 122 from the first profile 120 and form the tip 144.

In an aspect of the disclosure, in step 188 material is removed from the metal strip incident on the second stage 20. In one aspect of the disclosure, in step 188 metal is removed from the metal strip (first profile 120) incident on the second stage 20 to remove metal material along a side of the strip 10 at a distance away from the tip 144 formed in step 186. In this example aspect of the disclosure, in step 188 the coarse abrasive surface 53 in section 70 of the abrading wheels 22a, 22b adjacent to an exit end, such as the strip exiting end 27, abrades the first profile 120 of the metal strip at a low contact angle 69 (FIG. 4B) to remove section 124 (FIG. 6C) from the metal strip. In an example aspect of the disclosure, in step 188 the coarse abrasive surface 53 in section 70 abrades the first profile 120 in a direction along lines 126a, 126b (FIG. 6C) at the low contact angle 69 to remove the section 124 from the first profile 120. In this example aspect of the disclosure, in step 188 the section 124 (FIG. 6C) is removed to form the second profile 140 with the tip 144 that has improved blade qualities (e.g. improved smoothness and reduced values for T4, T8, T16, T40). Additionally, in some aspects of the disclosure, in progressing through steps 186 through 188, the sections 122 and 124 are removed in a downward direction (looking at FIG. 6C) so that the pressure of removal of section 124 does not contact and thus affect the formed tip 144 in previous step 186.

In some aspects of the disclosure, between steps 186 and 188, the other sections 72, 74 of the abrasive surface 53 of the abrading wheels 22a, 22b abrade the metal strip and remove other sections from the first profile 120. In one example aspect of the disclosure, the other sections 72, 74 abrade the first profile 120 of the metal strip at a contact angle (e.g. between the low contact angle 69 and the high contact angle 67) to remove other sections than sections 122, 124 (e.g. section 123 between these sections 122, 124 in FIG. 6C) or remove part of the same sections 122, 124 depicted in FIG. 6C.

Thus, in these aspects of the disclosure, the removal of material from the first profile 120 of the metal strip does not merely involve steps 186, 188 that occur at the strip receiving and strip exiting ends 25, 27 and instead is continuously performed by the varying coarseness sections 70, 72, 74, 76 that make continuous contact with the metal strip between the strip receiving and strip exiting ends 25, 27 of the second stage 20.

It was recognized that the improved apparatus disclosed herein provides noticeable advantages over the prior art. For example, stress was substantially relieved on the metal strip during the stages of forming the cutting edge. This is due to the improved apparatus which added an additional stage (e.g. intermediate second stage) and thus spread the volume of material to be removed from the metal strip over a larger number of stages, resulting in reduced stress on the metal strip. Additionally, the combination of the tilt angle, spiral helix orientation of the lands and coarseness variation (e.g. from fine to coarse) of the second stage reduced the amount of stress at the tip while maintaining contact with the strip as the abrasive surface moved away from the tip and towards the body of the strip. This advantageously reduced the stress levels while also 10 enhancing the edge quality. It was also recognized that the improved second stage with the coarseness variation also improved the cutting force of the blade through the hair by having the coarse abrasive surface contact the strip at the strip exiting end of the stage, reducing a flank thickness in the 20-40 μm region from the tip, which is a driver of the cutting force even though displaced from the tip.

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any disclosure disclosed or claimed herein or that it alone, or in any combination with any other reference or references, teaches, suggests or discloses any such disclosure. Further, to the extent that any meaning or definition of a term in this document conflicts with any meaning or definition of the same term in a document incorporated by reference, the meaning or definition assigned to that term in this document shall govern.

While particular aspects of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A method for providing cutting edges, comprising:
providing a grinding stage comprising a pair of abrading wheels that extend from a strip receiving end to a strip exiting end;
directing a strip of metal at the strip receiving end of the grinding stage along a path P; and
removing material, from the strip of metal, with an abrasive surface along the pair of abrading wheels which varies from a fine abrasion to a coarse abrasion in a direction from the strip receiving end to the strip exiting end.

2. The method of claim 1, further comprising:
removing material, from the strip of metal, with a first grinding stage to form a first profile;
wherein the directing step comprises directing the metal strip with the first profile from the first grinding stage along the path P to the strip receiving end of the grinding stage that faces the first grinding stage; and
wherein the removing material with the abrasive surface comprises removing material from the first profile to form a second profile.

3. The method of claim 1, wherein the removing material step comprises:
removing material, from a tip of the strip of metal, with the abrasive surface having the fine abrasion adjacent the strip receiving end; and
removing material, along a distance from the tip of the strip of metal, with the abrasive surface having the coarse abrasion adjacent the strip exiting end.

4. The method of claim 3, wherein:
wherein the removing material from the tip of the strip of metal comprises orienting the abrasive surface having the fine abrasion at a first contact angle between a first direction orthogonal to the path P and a second direction between the tip of the strip and a center of rotation of the pair of abrading wheels at the strip receiving end; and
wherein the removing material along the distance from the tip comprises orienting the abrasive surface having the coarse abrasion at a second contact angle between the first direction orthogonal to the path P and a third direction between the tip of the strip and a center of rotation of the pair of abrading wheels at the strip exiting end, wherein the second contact angle is less than the first contact angle.

5. The method of claim 1, wherein the providing the grinding stage further comprises orienting axes of the pair of abrading wheels at a tilt angle such that the axes are more proximate to the path P at the strip exiting end than the strip receiving end.

6. The method of claim 5, wherein the tilt angle is selected such that during the removing step a contact angle between a first direction orthogonal to the path P and a second direction between a tip of the strip and a center of rotation of the pair of abrading wheels diminishes in said direction from said strip receiving end to said strip exiting end.

7. The method of claim 1,
wherein the providing step comprises arranging a plurality of lands that include the abrasive surface in a spiral helix on each of said pair of abrading wheels; and
wherein the removing step comprises contacting, with the spiral helix, the strip of metal in a direction from a tip of the strip of metal to a body of the strip of metal as the strip of metal moves from the strip receiving end to the strip exiting end of the grinding stage.

8. The method of claim 7, wherein the spiral helix is a right-handed thread on one abrading wheel of the pair of abrading wheels and a left-handed thread on another abrading wheel of the pair of abrading wheels.

9. The method of claim 1,
wherein the providing the grinding stage comprises providing the abrasive surface with a plurality of sections between the strip receiving end and the strip exiting end including a first section with a fine abrasive surface adjacent the strip receiving end and a second section with a coarse abrasive surface adjacent the strip exiting end; and
wherein the removing step comprises;
contacting, with the fine abrasive surface of the first section, a tip of the strip of metal, and
contacting, with the coarse abrasive surface of the second section, a distance back from the tip of the strip of metal.

10. The method of claim 9, wherein the coarse abrasive surface is more coarse than the fine abrasive surface and wherein the plurality of sections further includes a third section between the first section and the second section and wherein the third section comprises an abrasive surface that is more coarse than the fine abrasive surface of the first section and less coarse than the coarse abrasive surface of the second section; and
wherein the removing step further comprises contacting, with the abrasive surface of the third section, a portion of the strip between the tip and the distance back from the tip.

11. The method of claim 9,
wherein the contacting the tip of the strip with the fine abrasive surface comprises orienting the fine abrasive surface at a first contact angle between a first direction orthogonal to the path P and a second direction between the tip of the strip and a center of rotation of the pair of abrading wheels at the strip receiving end; and
wherein the contacting the distance back from the tip with the coarse abrasive surface comprises orienting the coarse abrasive surface at a second contact angle between the first direction orthogonal to the path P and a third direction between the tip of the strip and a center of rotation of the pair of abrading wheels at the strip exiting end, wherein the second contact angle is less than the first contact angle.

12. The method of claim 9, wherein the contacting the distance back from the tip with the coarse abrasive surface comprises directing removed material from the distance back from the tip in a direction away from the tip of the strip of metal.

13. A method for forming cutting edges comprising:
providing a grinding stage including a pair of abrading wheels that extend from a strip receiving end to a strip exiting end, wherein the pair of abrading wheels each comprise an abrasive surface that varies from a fine abrasion to a coarse abrasion in a direction from the strip receiving end to the strip exiting end; and
removing, with the abrasive surface of the pair of abrading wheels, material from a strip of metal incident on the strip receiving end along a path P, comprising;
removing material, from a tip of the strip of metal, with the abrasive surface having the fine abrasion, and
removing material, along a distance from the tip of the strip of metal, with the abrasive surface having the coarse abrasion.

14. The method of claim 13, further comprising:
removing, with a first grinding stage, metal from the strip incident on the first grinding stage along the path P to form a first profile; and
wherein the removing with the abrasive surface comprises removing material from the first profile of the strip of metal to form a second profile.

15. The method of claim 13, wherein:
the removing material from the tip with the abrasive surface having the fine abrasion is performed adjacent the strip receiving end; and
the removing material along the distance from the tip with the abrasive surfacing having the coarse abrasion is performed adjacent the strip exiting end.

16. The method of claim 15, wherein:
wherein the removing material from the tip of the strip of metal comprises orienting the abrasive surface having the fine abrasion at a first contact angle between a first direction orthogonal to the path P and a second direction between the tip of the strip and a center of rotation of the pair of abrading wheels at the strip receiving end; and
wherein the removing material along the distance from the tip comprises orienting the abrasive surface having the coarse abrasion at a second contact angle between the first direction orthogonal to the path P and a third direction between the tip of the strip and a center of rotation of the pair of abrading wheels at the strip exiting end, wherein the second contact angle is less than the first contact angle.

17. The method of claim 13, wherein the providing the grinding stage further comprises orienting axes of the pair of abrading wheels at a tilt angle such that the axes are more proximate to the path P at the strip exiting end than the strip receiving end.

18. The method of claim 17, wherein the tilt angle is selected such that during the removing step a contact angle between a first direction orthogonal to the path P and a second direction between a tip of the strip and a center of rotation of the pair of abrading wheels diminishes in said direction from said strip receiving end to said strip exiting end.

19. The method of claim 13,
wherein the providing step comprises arranging a plurality of lands that include the abrasive surface in a spiral helix on each of said pair of abrading wheels such that the spiral helix includes a right-handed thread on one abrading wheel of the pair of abrading wheels and a left-handed thread on another abrading wheel of the pair of abrading wheels; and
wherein the removing step comprises contacting, with the spiral helix, the strip of metal in a direction from a tip of the strip of metal to a body of the strip of metal as the strip of metal moves from the strip receiving end to the strip exiting end of the grinding stage.

20. A method for forming cutting edges comprising:
directing a strip of metal along a path P;
removing, with a first grinding stage including a pair of abrading wheels, material from the strip of metal incident on the first grinding stage along the path P to form a first profile;
removing, with a second grinding stage including a pair of abrading wheels that extend from a strip receiving end to a strip exiting end, material from the first profile of the strip of material incident on the strip receiving end of the second grinding stage to form a second profile, including;
removing, with a fine abrasive surface of the pair of abrading wheels adjacent the strip receiving end, material from a tip of the first profile of the strip of metal to form a tip of the second profile; and
removing, with a coarse abrasive surface of the pair of abrading wheels adjacent the strip exiting end, material along a distance from the tip of the second profile of the strip of metal such that the removed material is directed away from the tip of the second profile.
